(19) United States
(12) Patent Application Publication
(10) Pub. No.: US 2003/0061083 A1
(43) Pub. Date: Mar. 27, 2003

(54) Engineer's productivity evaluation method

(75) Inventors: Yasumasa Nishimura, Tokyo (JP); Katsuji Kawaguchi, Tokyo (JP); Mamoru Miyamoto, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 10/096,495

(22) Filed: Mar. 13, 2002

(30) Foreign Application Priority Data
Sep. 26, 2001 (JP) 2001-294607

(51) Int. Cl. G06F 17/60

(52) U.S. Cl. 705/7

(57) ABSTRACT

An evaluation method that enables quantitative evaluation of qualitative index to engineer's productivity without influenced by a subjective judgments. A theme that is set as an engineer's productivity index that is qualitative, a target-converted amount of money or a target-converted numerical value that is set for the theme, a result of evaluation in predetermined evaluation levels that is performed regularly for the theme, and coefficients that are set for the respective evaluation levels are employed as data. A determined evaluation level is input to a computer at the time of evaluation for the theme and the computer calculates the product of a coefficient corresponding to the input evaluation level and the target-converted amount of money or numerical value and stores the calculated product.

### BACKGROUND OF THE INVENTION

1. Field of the Invention

The present invention relates to an engineer's productivity evaluation method and, more specifically, to a method for performing evaluation for an engineer's productivity indices quantitatively or both quantitatively and qualitatively using a computer.

2. Description of Related Art

FIGS. 8-10 show evaluation formats for description of conventional methods for an engineer's productivity evaluation. FIG. 8 shows a format 1 for evaluation for qualitative indices. FIGS. 9 and 10 show formats for evaluation for quantitative indices; FIG. 9 shows a format 2 for evaluation for the degrees of progress of technical development items and FIG. 10 shows a format 3 for evaluation for improvement work items such as cost reduction, yield increase, and manufacturing period shortening. As for qualitative indices as shown in the format 1 of FIG. 8 such as proposals of development of innovative technologies, proposals of new techniques relating to tests, and activities for activating engineers, a manager evaluates self-assessment results of each engineer regularly, for example, every three months. It is a common procedure to use four evaluation levels of “;” (good), “<” (average), × (improvement required), and “−” (no evaluation).

As for the degrees of progress of technical development items as shown in the format 2 of FIG. 9 and improvement work items as shown in the format 3 of FIG. 10 such as cost reduction, yield increase, and manufacturing period shortening, since the target (or schedule) of each item is expressed quantitatively in the form of a number or the like, results is followed for each development theme or product type regularly, for example, every three months and a manager evaluates each result in accordance with the magnitude of a result value relative to a plan value using four evaluation levels as mentioned above.

In the above conventional methods for an engineer's productivity evaluation, a manager performs evaluation alone and hence evaluation results tend to vary depending on his subjective judgments. Further, since no evaluation criterion is provided for each level, the four-level evaluation has a problem that it tends to be influenced by a manager's subjective judgments and has difficulty in providing objective evaluation results.

### SUMMARY OF THE INVENTION

The present invention has been made to solve the above problems in the art, and an object of the invention is therefore to provide an engineer's productivity evaluation method that is computer-processible, is not influenced much by a manager's subjective judgments, and enables quantitative evaluation based on objective criteria.

According to a first aspect of the present invention, there is provided an engineer's productivity evaluation method, the method employs data including a theme that is set as an engineer's productivity index that is qualitative, a target-converted amount of money or a target-converted numerical value that is set for the theme, a result of evaluation in predetermined levels that is performed regularly for the theme and coefficients that are set for the respective evaluation levels; the method comprising the steps of: inputting an evaluation level to a computer at a time of evaluation for the theme; calculating a product of a coefficient corresponding to the input evaluation level and the target-converted amount of money or numerical value; and storing the product calculated in the step of calculating.

According to a second aspect of the present invention, there is provided an engineer's productivity evaluation method, the method employs data including themes that are set as an engineer's productivity indices that are qualitative, target-converted amounts of money or target-converted numerical values that are set for the respective themes, results of evaluation in predetermined levels that is performed regularly for the respective themes and coefficients that are set for the respective evaluation levels, the quantitative evaluation and qualitative evaluation are performed for the themes, the method comprising the steps of: calculating products of coefficients corresponding to determined evaluation levels and the target-converted amounts of money or the target-converted numerical values, the predetermined evaluation levels having four evaluation levels that are a first evaluation level that is given when a first predetermined number or more of a plurality of evaluation committee members including a manager of the engineer judge that a result is sufficient, a second evaluation level that is given when part of the evaluation committee members that are less than the first predetermined number and more than or equal to a second predetermined number judge that the result is sufficient, a third evaluation level that is given when less than the second predetermined number of the evaluation committee members judge that the result is sufficient, and a fourth evaluation level that is given when a third predetermined number or more of the evaluation committee members do not make clear evaluation; performing the qualitative evaluation using the number of determined first evaluation levels and the number of determined third evaluation levels; and inputting and adding up, by the computer, results of the quantitative evaluation and results of the qualitative evaluation, whereby total evaluation is made.

According to a third aspect of the present invention, there is provided an engineer's productivity evaluation method, the method employs data including a theme that is set as an engineer's productivity index that is quantitative, a target amount of money or a target numerical value that is set for the theme and a result amount of money or a result numerical value that is checked regularly for the theme, the method comprising the step of: calculating, by a computer, a relationship between the target amount of money or numerical value and the result amount of money or numerical value, whereby evaluation is performed in predetermined evaluation levels.

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows a computer format 4 in which qualitative ones among an engineer's productivity indices and their evaluation results can be entered.

FIG. 2 shows a format 5 for description of an evaluation method according to the second embodiment.

FIG. 3 shows a format 6, with which the degrees of progress of technical development items (examples of quantitative indices) are visualized theme by theme through indication using arrows (unit: one month).

FIG. 4 shows a computer format 7 for evaluation for improvement work items.

FIG. 5 shows a computer format 8 for evaluation for mass-production work items.

FIG. 6 shows a computer format 9 for evaluation for the numbers of inventions and ideas.

FIG. 7 shows a computer format 10 for adding-up of lost costs, that is, lost amounts of money.

FIG. 8 shows a format 1 for evaluation for qualitative indices of conventional methods for an engineer's productivity evaluation.

FIG. 9 shows a format 2 for evaluation for the degrees of progress of technical development items of conventional methods for an engineer's productivity evaluation.

FIG. 10 shows a format 3 for evaluation for improvement work items such as cost reduction, yield increase, and manufacturing period shortening of conventional methods for an engineer's productivity evaluation.

### DETAILED DESCRIPTION OF THE PREFERRED EMBODIMENTS

Embodiments of the present invention will be described below with reference to the accompanying drawings. It is noted that the same reference symbols in the drawings denote the same or corresponding components.

First Embodiment

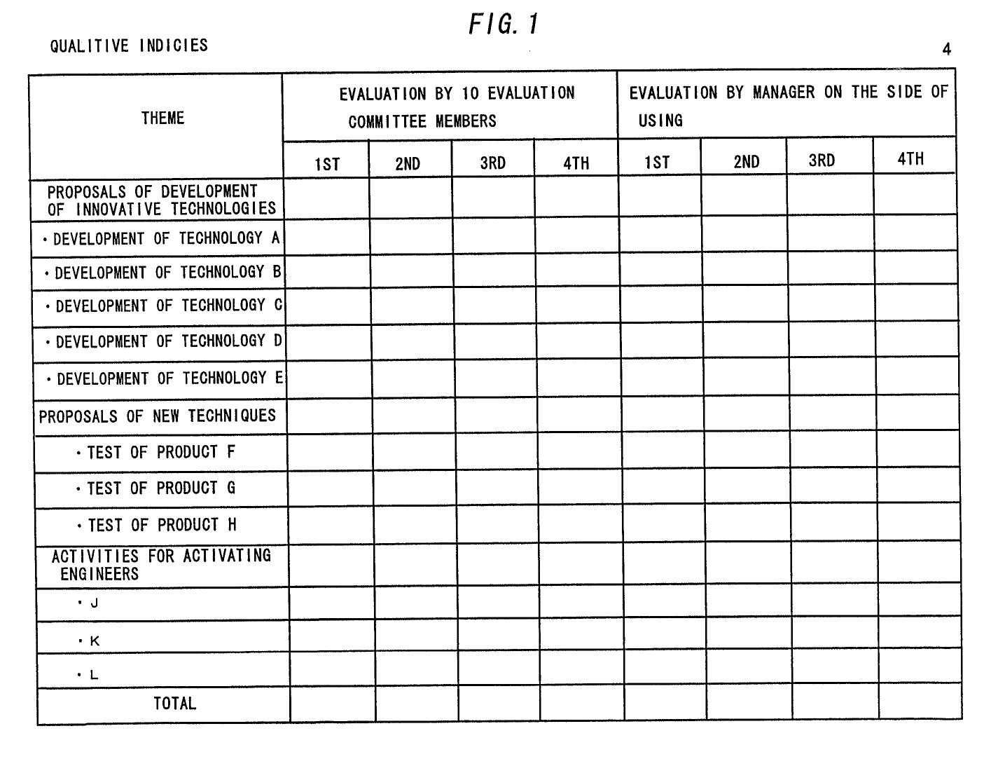

A first embodiment of the present invention will be described below with reference to FIG. 1. FIG. 1 shows a computer format 4 in which qualitative ones among an engineer's productivity indices and their evaluation results can be entered.

Among the examples of qualitative indices shown in the format 4 are proposals of development of innovative technologies that are shown as individual technical development themes of technology A, technology B, . . . and proposals of new techniques such as test techniques that are shown as test techniques for respective products of product F, product G, . . . .

Further, activities for activating engineers, which are themes that are difficult to evaluate but very important, are included as one category of indices.

Activities for activating engineers are what is called enlightenment movements. For example, encouragement for each engineer to attain a visible result based on his capabilities can be an important theme of this kind. Therefore, specific action guidelines J, K, and L that will lead to visible results are shown in the format 4.

As for the evaluation, a target-converted amount of money Y (million yen) or a target-converted numerical value X corresponding to it is set for each of the above-mentioned themes of proposals of development of innovative technologies and proposals of new techniques and the above-mentioned action guidelines of activating activities. The result of each item is subjected to four-level evaluation regularly, for example, every three months. One of coefficients Z (Z1-Z4) that are set for the respective evaluation levels and a target-converted amount of money Y or a target-converted numerical value X are input to a computer, and their product YZ or XZ is calculated and shown in the format 4 of FIG. 1 as an evaluation value of each time. As for the four-level evaluation, different evaluation criteria are employed for the proposals of new techniques and the other qualitative indices so that evaluation for the individual indices can be performed properly.

To increase the objectivity of evaluation, a plurality of evaluators consisting of development-side evaluators and an evaluator on the side of using a developed technology or technique are employed in contrast to the conventional case in which only one manager of a subject engineer in charge of development is employed as an evaluator.

To eliminate adverse effects of subjective judgments, the development-side evaluators are made a complex of 10 evaluation committee members including a manager of a subject engineer in charge of development. However, evaluation results of one manager are used as they are as evaluation results of the user-side evaluator, because it is difficult to ask a plurality of persons for evaluation.

The evaluation by the 10 evaluation committee members is performed based on self-assessment development results of a subject engineer in charge of development. First, a description will be made of evaluation criteria of the qualitative indices other than the proposals of new techniques.

Each evaluator committee member judges whether the result of each qualitative index theme is sufficient or insufficient. A four-level evaluation method is employed in which the subject engineer is given one of four evaluation levels, that is, he is given an evaluation result “;” (first level) if the judgment results of eight or more evaluation committee members are “sufficient,” an evaluation result “<” (second level) if the judgment results of five to seven members are “sufficient,” an evaluation result “×” (third level) if the judgment results of four or less members are “sufficient,” and an evaluation result “no evaluation” (fourth level) if five or more members cannot judge that the result is sufficient or insufficient. Predetermined coefficients Z1-Z4 are set for the respective evaluation levels.

As for the evaluation criteria for the themes that urge proposals of new techniques, a result is evaluated by the mutual consent of the 10 evaluation committee members and is given an evaluation result “;” (first level) if it is judged that a technique developed is one developed for the first time in the world, an evaluation result “<” (second level) if a technique developed is one developed for the first time in the U.S.A. or Japan, an evaluation result “×” (third level) if a technique developed is one developed for the first time in the company, and an evaluation result “no evaluation” (fourth level) if no evaluation result is reached. Predetermined coefficients Z1-Z4 are set for the respective evaluation levels.

An evaluation level symbol (;, <, ×, or −) and a YZ or XZ numerical value are entered in each space of the format 4 of FIG. 1. The sum of the numerical values of all themes is entered in a space “Total” to make it possible to recognize a total evaluation result of all themes as a comparison with the initial target value ((target-converted amount of money or numerical value)×(number of themes)).

Having the above features, the first embodiment enables quantitative, free-of-subjectiveness evaluation for themes that are set as an engineer's productivity indices that are qualitative, as well as computer processing. This makes it possible to check evaluation results of an engineer's productivity indices and to easily recognize his mental activities.

Second Embodiment

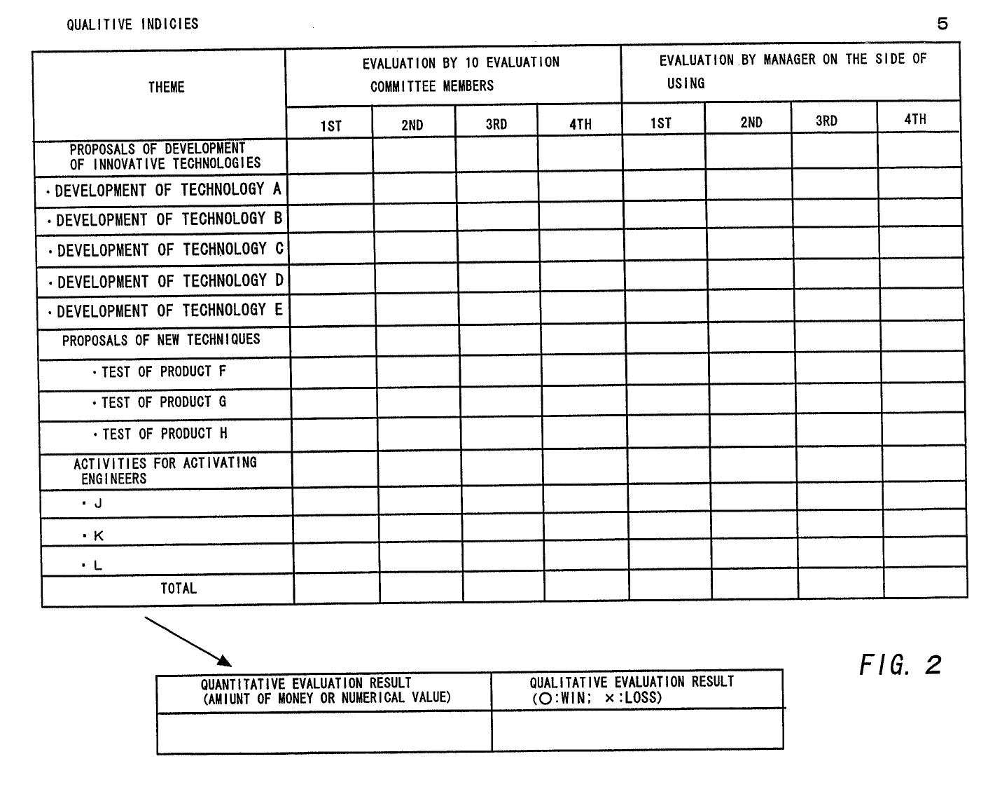

A second embodiment of the invention will be described below with reference to FIG. 2. FIG. 2 shows a format 5 for description of an evaluation method according to the second embodiment.

The themes of qualitative indices, the evaluators, and the evaluation spaces of each time in the format 5 of FIG. 2 are the same as in the format 4 of FIG. 1. The format 5 of FIG. 2 are the same as the format 4 of FIG. 1 in that one of the evaluation symbols (;, <, ×, and −) and a numerical value (YZ or XZ) are entered in each evaluation space. Descriptions for the above points will be omitted. The format 5 of FIG. 2 is different from the format 4 of FIG. 1 in that a quantitative evaluation result and a qualitative evaluation result are entered in the total space of each time (see enlarged spaces in the bottom part of FIG. 2).

As in the case of the format 4 of FIG. 1, the sum of numerical values of the evaluation spaces of each time is entered in the quantitative evaluation space of the total space. As for the qualitative evaluation, among the evaluation results (evaluation levels) of the respective themes of each time, evaluation results “;” (first level) and “×” (third level) are considered a win and a loss, respectively. The number of wins and the number of losses are counted for each time, and “5 wins and 1 loss,” for example, is entered in the qualitative evaluation space of the total space. This serves as another total evaluation result of all themes. Evaluation results “<” (second level) and “−” (fourth level) are not counted.

With the addition of the above qualitative evaluation, the number of themes that are given the first evaluation level (the result is judged sufficient) and the number of themes that are given the third evaluation level (the result is insufficient) can be recognized. A total evaluation result can be obtained in a form different than that represented by a numerical value whereby entire evaluation being easily understood.

Third Embodiment

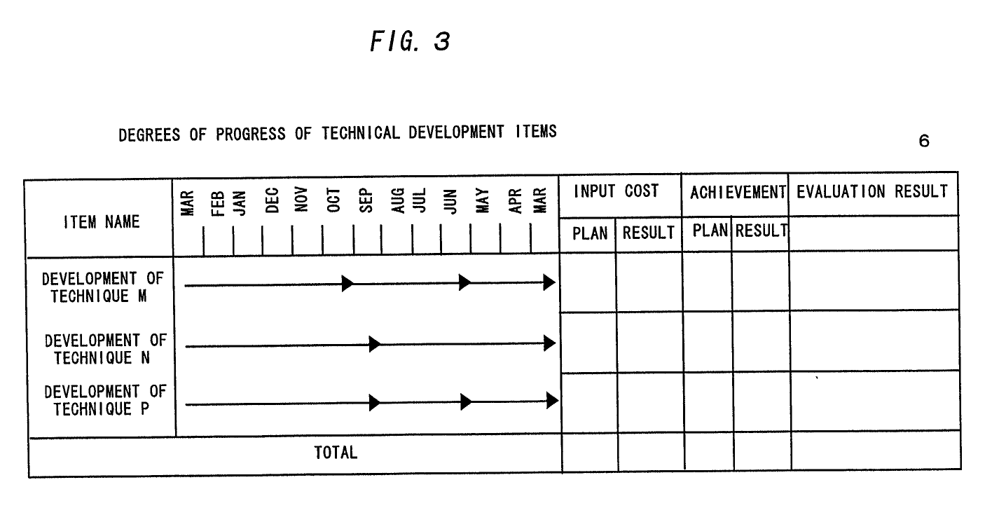

A third embodiment of the invention will be described below with reference to FIGS. 3-7. FIGS. 3-7 show computer formats in which quantitative ones among an engineer's productivity indices, their quantitative evaluation results, and evaluation results of the quantitative evaluation results can be entered. FIG. 3 shows a format 6, with which the degrees of progress of technical development items (examples of quantitative indices) are visualized theme by theme through indication using arrows (unit: one month). Further, for each development theme, an input cost (development cost, personnel expenses, equipment cost, etc.), an achievement, and an evaluation result of the achievement are entered through computer processing.

As for the input cost, a plan value and a result at each of regular evaluation time points (intervals: three months, for example) are entered as amounts of money. As for the achievement, an amount of money obtained by subtracting a development cost and applied expenses (personnel expenses, equipment cost, etc.) from conventional expenses (personnel expenses, equipment cost, etc.) is employed as a rough measure and an initial plan amount and a result at each of regular evaluation time points with respect to the measure are entered.

As for the evaluation result, a result at each of regular evaluation time points (intervals: three months, for example) is evaluated in four levels according to the following evaluation criteria. That is, an evaluation result “;” (first level) is given if a result exceeds a plan amount, an evaluation result “<” (second level) is given if the result is smaller than the plan amount by 10% or less, an evaluation result “×” (third level) is given if the result is smaller than the plan amount by more than 10%, and an evaluation result “−” (fourth level) is given if the development is stopped halfway. An evaluation result is obtained in the above manner through calculation by a computer. Predetermined coefficients or numerical values (W1-W4) are set for the respective evaluation levels. It is noted that the format 6 of FIG. 3 is a summary of totals of one-year achievements and their evaluation results.

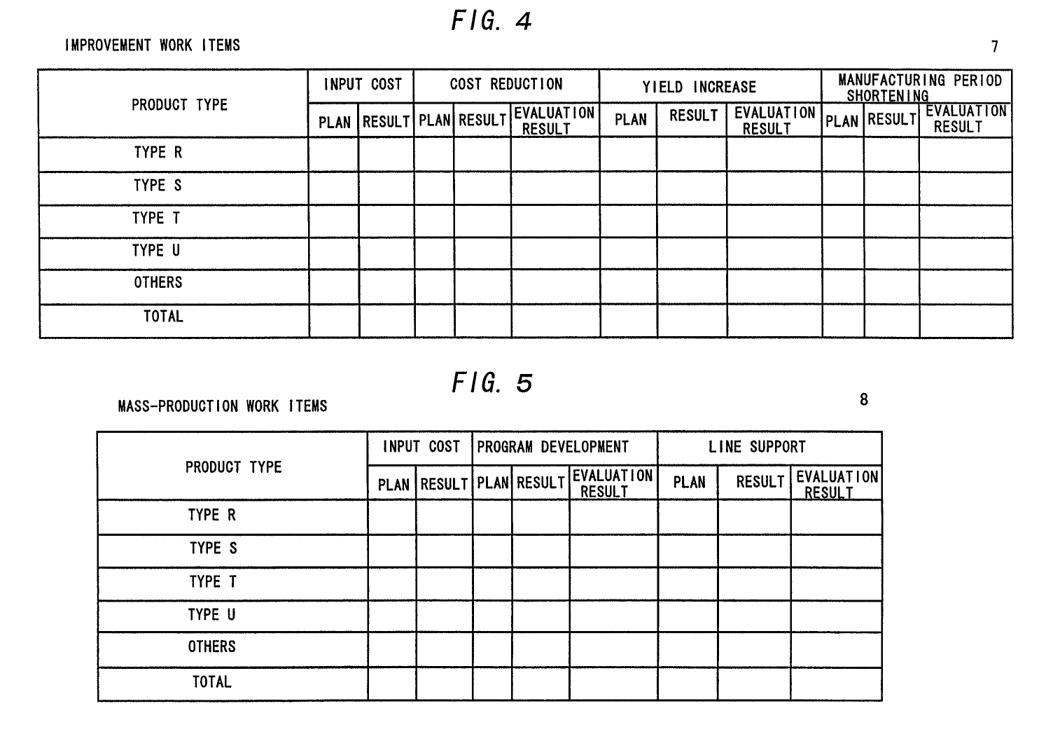

FIG. 4 shows a computer format 7 for evaluation for improvement work items. Evaluation spaces for a plan value (target numerical value), a result after a lapse of one year, and its evaluation result are provided for each product type (R, S, T, U, or others) and for each of improvement themes of cost reduction, yield increase, and manufacturing period shortening. (Although evaluation is performed every three months, for example, for each improvement theme, the format 7 is for one-year totals.)

As for the input cost, a plan value and a result of a total of costs input for each product type for each theme are entered. The evaluation for each improvement theme is performed in four levels in the same manner as described above with reference to FIG. 3. Computer calculation is performed for each improvement theme and for each product type.

As for the total, the above-mentioned four-level evaluation is performed for each improvement theme on the sum of results of all product types in comparison with the sum of plan values. Each total value is meaningful as a total evaluation result of all product types for the corresponding one of the improvement themes of cost reduction, yield increase, and manufacturing period shortening.

FIG. 5 shows a computer format 8 for evaluation for mass-production work items. Evaluation spaces for a plan value (target numerical value), a result after a lapse of one year, and its evaluation result are provided for each product type (R, S, T, U, or others) and for each of themes of program development and line support. (Although a status check and evaluation is performed every three months, for example, for each theme, the format 8 is for one-year totals.)

As for the input cost, a plan value and a result of a total of costs input for each product type for each theme are entered. The evaluation is performed in four levels in the same manner as described above with reference to the format 6 of FIG. 3. Computer calculation is performed for each improvement theme and for each product type.

As for the total, the above-mentioned four-level evaluation is performed for each theme on the sum of results of all product types in comparison with the sum of plan values. Each total value is meaningful as a total evaluation result of all product types for the corresponding one of the improvement themes of program development and line support.

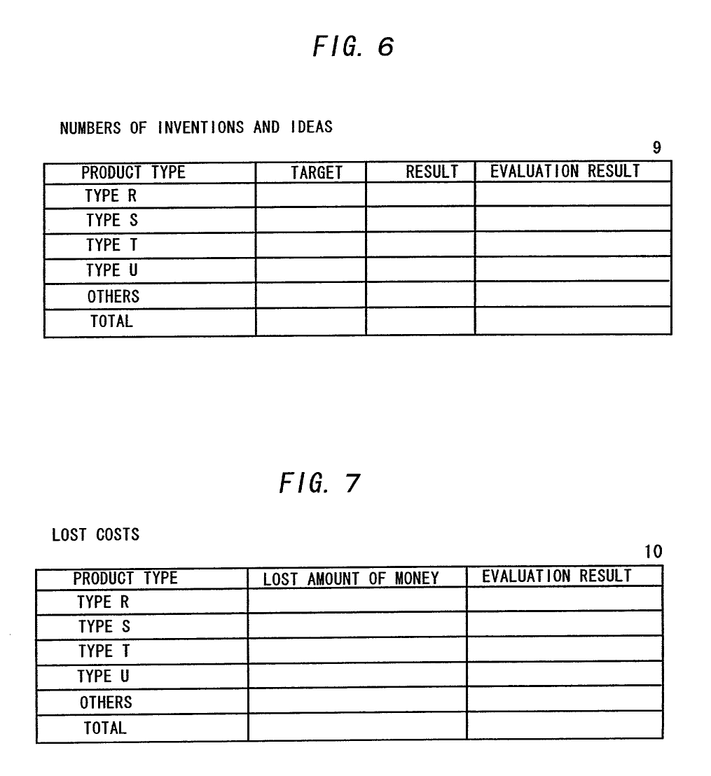

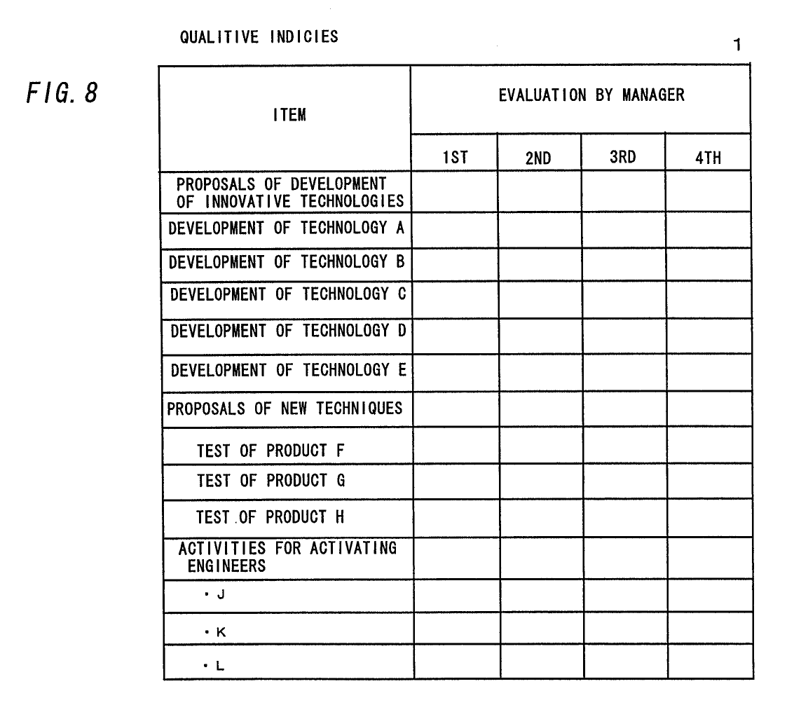

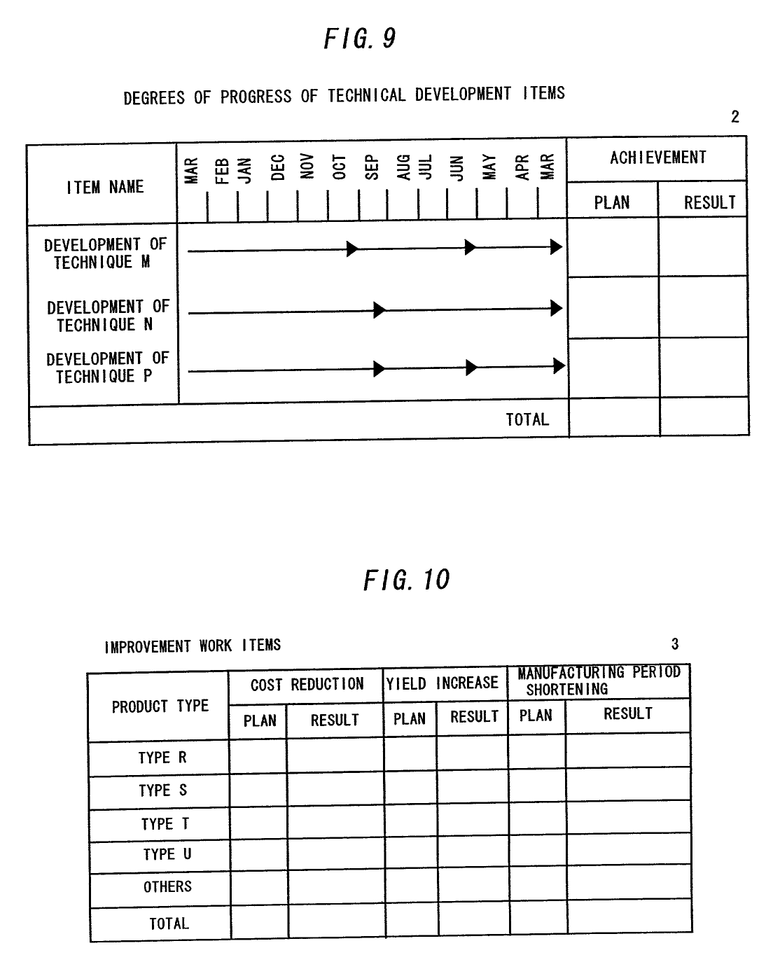

FIG. 6 shows a computer format 9 for evaluation for the numbers of inventions and ideas. Evaluation spaces for a target number, a result, and its evaluation result are provided for each product type (R, S, T, U, or others).

As in the case of the other productivity indices described above, results are checked and evaluation is made regularly (every three months). However, the format 9 is for one-year totals.

The evaluation is performed in four levels in the same manner as described above with reference to FIG. 3, and hence the evaluation method will not be described.

FIG. 7 shows a computer format 10 for adding-up of lost costs, that is, lost amounts of money. Lost costs are checked for each product type (R, S, T, U, or others). As in the case of the above-described themes, lost costs are added up and evaluated regularly.

An example of the lost cost is a lost amount of money that is determined by the yield of a product and its price. By adding up it and the other lost amounts of money regularly and evaluating a resulting total amount of money, problems can be made tangible and a subject engineer in charge of development can be made more aware of the importance of loss prevention.

In an engineer's productivity evaluation method according to one aspect of the invention, a theme that is set as an engineer's productivity index that is qualitative, a target-converted amount of money or a target-converted numerical value that is set for the theme, a result of evaluation in predetermined evaluation levels that is performed regularly for the theme, and coefficients that are set for the respective evaluation levels are employed as data; and a determined evaluation level is input to a computer at the time of evaluation for the theme and the computer calculates a product of a coefficient corresponding to the input evaluation level and the target-converted amount of money or numerical value and stores the calculated product. Therefore, results of regular evaluation for qualitative indices and quantitative indices can be added up automatically and can be visualized. Further, computer-processible quantitative evaluation can be performed without being influenced much by subjective judgments of a manager.

The evaluation is performed by a plurality of evaluation committee members including a manager of an engineer in charge of development and by a manager on the side of using a result of development of a productivity evaluation index. This enables highly objective evaluation.

The evaluation levels for evaluation for a theme that is set as a qualitative index are four evaluation levels that are a first evaluation level that is given when a first predetermined number or more of a plurality of evaluation committee members including a manager of an engineer in charge of development judge that a result is sufficient, a second evaluation level that is given when part of the evaluation committee members that are less than the first predetermined number and more than or equal to a second predetermined number judge that the result is sufficient, a third evaluation level that is given when less than the second predetermined number of the evaluation committee members judge that the result is sufficient, and a fourth evaluation level that is given when a third predetermined number or more of the evaluation committee members do not make clear evaluation. This enables quantitative evaluation for a qualitative index.

The evaluation levels for a theme that urges a proposal of a new technique such as a test technique among themes that are set as qualitative indices are four evaluation levels that are a first evaluation level that is given to a proposal that has been made for the first time in the world, a second evaluation level that is given to a proposal that has been made for the first time in the U.S.A. or Japan, a third evaluation level that is given to a proposal that has been made for the first time in a company concerned, and a fourth evaluation level that is given to a proposal that is not evaluated clearly. This enables proper evaluation of a new technique that is difficult to evaluate.

Evaluation for qualitative productivity indices is performed both quantitatively and qualitatively. This enables more proper evaluation for productivity indices.

In an engineer's productivity evaluation method according to another aspect of the invention, a theme that is set as an engineer's productivity index that is quantitative, a target amount of money or a target numerical value that is set for the theme, and a result amount of money or a result numerical value that is checked regularly for the theme are employed as data; and a computer calculates a relationship between the target amount of money or numerical value and the result amount of money or numerical value, whereby evaluation is performed in predetermined evaluation levels. This facilitates evaluation for quantitative indices and enables highly objective evaluation.

The predetermined evaluation levels for evaluation for a theme that is set as a quantitative index are four evaluation levels that are a first evaluation level that is given when the result amount of money or numerical value exceeds the target amount of money or numerical value, a second evaluation level that is given when the result amount of money or numerical value is smaller than the target amount of money or numerical value by a predetermined percentage or less, a third evaluation level that is given when the result amount of money or numerical value is smaller than the target amount of money or numerical value by more than the predetermined percentage, and a fourth evaluation level that is given when development of the theme stopped halfway. The employment of the four-level evaluation enables highly objective evaluation.

In the engineer's productivity evaluation method, the evaluation may be performed by a plurality of evaluation committee members including a manager of the engineer and by a manager on a side of using a result of development of the theme.

In the engineer's productivity evaluation method, the evaluation levels may have four evaluation levels that are a first evaluation level that is given when a first predetermined number or more of a plurality of evaluation committee members including a manager of the engineer judge that a result is sufficient, a second evaluation level that is given when part of the evaluation committee members that are less than the first predetermined number and more than or equal to a second predetermined number judge that the result is sufficient, a third evaluation level that is given when less than the second predetermined number of the evaluation committee members judge that the result is sufficient, and a fourth evaluation level that is given when a third predetermined number or more of the evaluation committee members do not make clear evaluation.

In the engineer's productivity evaluation method, the evaluation levels for a theme that urges a proposal of a new technique such as a test technique among themes that are set as qualitative indices may have four evaluation levels that are a first evaluation level that is given to a proposal that has been made for the first time in the world, a second evaluation level that is given to a proposal that has been made for the first time in the U.S.A, a third evaluation level that is given to a proposal that has been made for the first time in a company concerned, and a fourth evaluation level that is given to a proposal that is not evaluated clearly.

In the engineer's productivity evaluation method, the predetermined evaluation levels may have four evaluation levels that are a first evaluation level that is given when the result amount of money or numerical value exceeds the target amount of money or numerical value, a second evaluation level that is given when the result amount of money or numerical value is smaller than the target amount of money or numerical value by a predetermined percentage or less, a third evaluation level that is given when the result amount of money or numerical value is smaller than the target amount of money or numerical value by more than the predetermined percentage, and a fourth evaluation level that is given when development of the theme stopped halfway.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

The entire disclosure of Japanese Patent Application No. 2001-294607 filed on Sep. 26, 2001 including specification, claims, drawings and summary are incorporated herein by reference in its entirety.

What is claimed is:

1. An engineer's productivity evaluation method, the method employs data including a theme that is set as an engineer's productivity index that is qualitative, a target-converted amount of money or a target-converted numerical value that is set for the theme, a result of evaluation in predetermined levels that is performed regularly for the theme and coefficients that are set for the respective evaluation levels; the method comprising the steps of:
inputting an evaluation level to a computer at a time of evaluation for the theme;
calculating a product of a coefficient corresponding to the input evaluation level and the target-converted amount of money or numerical value; and
storing the product calculated in said step of calculating.

2. The engineer's productivity evaluation method according to claim 1, wherein the evaluation is performed by a plurality of evaluation committee members including a manager of the engineer and by a manager on a side of using a result of development of the theme.

3. The engineer's productivity evaluation method according to claim 1, wherein the evaluation levels have four evaluation levels that are a first evaluation level that is given when a first predetermined number or more of a plurality of evaluation committee members including a manager of the engineer judge that a result is sufficient, a second evaluation level that is given when part of the evaluation committee members that are less than the first predetermined number and more than or equal to a second predetermined number judge that the result is sufficient, a third evaluation level that is given when less than the second predetermined number of the evaluation committee members judge that the result is sufficient, and a fourth evaluation level that is given when a third predetermined number or more of the evaluation committee members do not make clear evaluation.

4. The engineer's productivity evaluation method according to claim 1, wherein the evaluation levels for a theme that urges a proposal of a new technique such as a test technique among themes that are set as qualitative indices have four evaluation levels that are a first evaluation level that is given to a proposal that has been made for the first time in the world, a second evaluation level that is given to a proposal that has been made for the first time in the U.S.A., a third evaluation level that is given to a proposal that has been made for the first time in a company concerned, and a fourth evaluation level that is given to a proposal that is not evaluated clearly.

5. An engineer's productivity evaluation method, the method employs data including themes that are set as an engineer's productivity indices that are qualitative, target-converted amounts of money or target-converted numerical values that are set for the respective themes, results of evaluation in predetermined levels that is performed regularly for the respective themes and coefficients that are set for the respective evaluation levels, the quantitative evaluation and qualitative evaluation are performed for the themes, the method comprising the steps of:
calculating products of coefficients corresponding to determined evaluation levels and the target-converted amounts of money or the target-converted numerical values, the predetermined evaluation levels having four evaluation levels that are a first evaluation level that is given when a first predetermined number or more of a plurality of evaluation committee members including a manager of the engineer judge that a result is sufficient, a second evaluation level that is given when part of the evaluation committee members that are less than the first predetermined number and more than or equal to a second predetermined number judge that the result is sufficient, a third evaluation level that is given when less than the second predetermined number of the evaluation committee members judge that the result is sufficient, and a fourth evaluation level that is given when a third predetermined number or more of the evaluation committee members do not make clear evaluation;
performing the qualitative evaluation using the number of determined first evaluation levels and the number of determined third evaluation levels; and
inputting and adding up, by the computer, results of the quantitative evaluation and results of the qualitative evaluation, whereby total evaluation is made.

6. An engineer's productivity evaluation method, the method employs data including a theme that is set as an engineer's productivity index that is quantitative, a target amount of money or a target numerical value that is set for the theme and a result amount of money or a result numerical value that is checked regularly for the theme, the method comprising the step of:
calculating, by a computer, a relationship between the target amount of money or numerical value and the result amount of money or numerical value, whereby evaluation is performed in predetermined evaluation levels.

7. The engineer's productivity evaluation method according to claim 6, wherein the predetermined evaluation levels have four evaluation levels that are a first evaluation level that is given when the result amount of money or numerical value exceeds the target amount of money or numerical value, a second evaluation level that is given when the result amount of money or numerical value is smaller than the target amount of money or numerical value by a predetermined percentage or less, a third evaluation level that is given when the result amount of money or numerical value is smaller than the target amount of money or numerical value by more than the predetermined percentage, and a fourth evaluation level that is given when development of the theme stopped halfway.
